(19) United States
(12) Patent Application Publication
(10) Pub. No.: US 2023/0376831 A1
(43) Pub. Date: Nov. 23, 2023

(54) CORRELATION MODEL INTERPRETER USING TEACHER-STUDENT MODELS

(71) Applicant: Microsoft Technology Licensing, LLC, Redmond, WA (US)

(72) Inventors: Jimmy Chi Kin WONG, Arlington, VA (US); Rakesh J. NAMINENI, Sammamish, WA (US); Mohit VERMA, Seattle, WA (US)

(73) Assignee: Microsoft Technology Licensing, LLC, Redmond, WA (US)

(21) Appl. No.: 17/746,457

(22) Filed: May 17, 2022

(51) Int. Cl. G06N 20/00

(52) U.S. Cl. CPC G06N 20/00

(57) ABSTRACT

Systems and methods are provided for interpreting a correlation model that predicts a correlation between a pair of data corresponding to a pair of incident tickets using an interpreter model. The correlation model includes a Siamese Network including a plurality of neural networks. The interpreter model, trained by using training data, represents a student model (a glass-box model) while the correlation model, trained using the training data, represents a more complex teacher model (a black-box mode) of a teacher-student model. The present disclosure generates global feature importance scores based on the trained interpreter model, which indicates a degree of influence of a feature compared to other features in incident data in determining correlations, to generate additional training data emphasizing influential features and to retrain the correlation model. The present disclosure further determines local feature importance scores based on the trained interpreter model for confirming an accuracy of predicting correlations.

### BACKGROUND

Siamese Network predicts correlation between two or more incidents using two or more neural networks in parallel and comparing embeddings of input data. An issue arises when it becomes too complex to interpret a behavior of a Siamese Network. Accordingly, there arises a need to use the Siamese Network for predicting correlations among data while interpreting a behavior of the Siamese Network with efficiency

It is with respect to these and other general considerations that the aspects disclosed herein have been made. In addition, although relatively specific problems may be discussed, it should be understood that the examples should not be limited to solving the specific problems identified in the background or elsewhere in this disclosure.

### SUMMARY

Aspects of the present disclosure relate to a system for interpreting a correlation model using an interpreter model. The correlation model predicts a correlation between at least a pair of data. Examples of data include incident data associated with errors occurring in system operations in the cloud network. In particular, the disclosed technology uses a teacher-student model where the correlation model represents a teacher model or a complex, black-box model, and the interpreter model represents a student model or a simpler, glass-box model. An example of the correlation model includes a Siamese network, whereas an example of the interpreter model includes less complex machine learning models including Random Forest and the like. A same set of training data is used to train both the correlation model and the interpreter model.

Once trained the interpreter model receives embeddings associated with features of incident data and interprets behavior of the correlation model by generating embeddings at an incident level. A term “global feature importance scores” herein refers to a distribution of scores of correlations among features (e.g., attribute fields) across data. The disclosed technology generates a global feature importance score based on embeddings output from the interpreter model. The global feature importance score is based on aggregated correlation scores for features of the incident data, thereby identifying one or more features to emphasize in improving a performance of the correlation model. The global feature importance score may be used to generate training data with an emphasis on particular features for training the correlation model.

A term “local feature importance score” refers to a distribution of scores of correlations among words in feature values between a pair of data. The local feature importance score is generated based on embeddings as output from the interpreter model. The local feature importance scores are used in graphically presenting correlations between a pair of incident data associated with incidents for interactively comparing the correlation with manual assessments of the incidents by the users. Accordingly, the present disclosure interprets behavior of the correlation model as a teacher model by generating and using the simpler interpreter model. The interpretations include one or both of generating training data with emphases on particular features and interactively displaying correlation data at an incident level.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for determining correlations among data using a correlation model and interpreting the correlation model in accordance with aspects of the present disclosure.

FIG. 2 illustrates an overview of data structures in accordance with aspects of the present disclosure.

FIG. 3 illustrates an example data structures in accordance with aspects of the present disclosure.

FIG. 4A illustrates an example of global feature importance scores in accordance with aspects of the present disclosure.

FIG. 4B illustrates an example of local feature importance scores in accordance with aspects of the present disclosure.

FIG. 5 illustrates an example of a method for interpreting a correlation model in accordance with aspects of the present disclosure.

FIG. 6 is a block diagram illustrating example physical components of a computing device with which aspects of the disclosure may be practiced.

FIG. 7A is a simplified diagram of a mobile computing device with which aspects of the present disclosure may be practiced.

FIG. 7B is another simplified block diagram of a mobile computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

A correlation model predicts correlation between a pair of data and/or among multiple data. For example, operating an incident management system may determine a correlation between two incidents using a correlation model. Examples of a correlation model may include a Siamese Network. A Siamese network includes two or more neural networks in parallel. To predict correlation between two incidents, a Siamese network may receive two incidents, each including values associates features of incidents. Using two sets of neural networks, the Siamese Network generates two sets of embeddings for the two incidents. The Siamese Network generates Siamese embeddings, which are a combination of the two sets of embeddings that correspond to the two incidents. The resulting Siamese embeddings indicate whether the two incident cases are similar or distinct as a label. A Siamese Network may be trained using training data. The training data may include a pair of incidents (e.g., features) and a label that indicates whether the pair of incidents are correlated. A set of training data may include permutative pairs of incidents and respective labels of correlation.

Interpreting behavior of a correlation model is important in operating an incident managements system. In particular, the interpretation allows for determining how to train the correlation model to improve the accuracy of predicting similarities. The interpretation further enables determining whether output of the correlation model based on given input agrees with traditional and heuristic assessments. A successful interpretation of the correlation model pinpoints important features for a prediction and confirm an alignment between a correlation and human knowledge.

The present disclosure interprets a behavior of the Siamese Network for a number of different purposes. A first is to identify global feature importance of features in incident data. The global feature importance indicates features that are likely to be influential in improving accuracy of predicting correlations between incident data. The Siamese Network may be retrained based on training that emphasizes ground truth examples associated with the identified features. Using the features that are determined from the global feature importance enables the disclosure to focus on specific sets of training data to train the Siamese Network, reducing a burden of training based on permutative combination of sample incidents for training.

A second is local feature importance. The local feature importance indicates features with at least a part of content, which are important in assessing a correlation between a pair of incident data. A link between a pair of incident data based on features according to the local feature importance may be used to confirm whether the correlation as predicted by the correlation model aligns with a correlation that are heuristically determined without using prediction models. While specific purposes are described in this disclosure, one of skill in the art will appreciate that the aspects disclosed herein may also be employed to accomplish other goals and, as such, the exemplary purposes described herein should not be construed as limiting the scope of this disclosure.

As discussed in more detail below, the present disclosure is directed to interpreting a behavior of a correlation model using an interpreter model. In particular, the disclosed technology uses a teacher-student model where the correlation model is the teacher model (e.g., a black-box model) and the interpreter model is the student model (e.g., the glass-box model). In aspects, the correlation model is too complex to determine its behavior. Use of the teacher-student model enables interpreting a behavior of the correlation model by determining a behavior of the interpreter model, which is simpler than the correlation model. In aspects, the correlation model is based on a Siamese network, which includes a plurality of neural networks in parallel to determining similarity between the plurality of data (e.g., incident cases).

The disclosed technology includes automatically generating global feature importance scores and local feature importance scores based on the interpreter model. The global feature importance scores are based on aggregated correlation scores for respective features or attribute fields in data. The disclosed technology determines one or more features to emphasize in generating training data for training the correlation model. The local feature importance scores include predictions of correlations between words that appear in a pair of data. For example, the pair of data includes a pair of incident data for comparison. The disclosed technology causes interactive review of the local feature importance scores by the users (e.g., on-call engineers) to confirm whether the predicted correlations between the pair of incidents are in line with manual assessments by the users. A use of the interpreter model as a student model of the teacher-student model enables determining of a behavior of the correlation model as a teacher model.

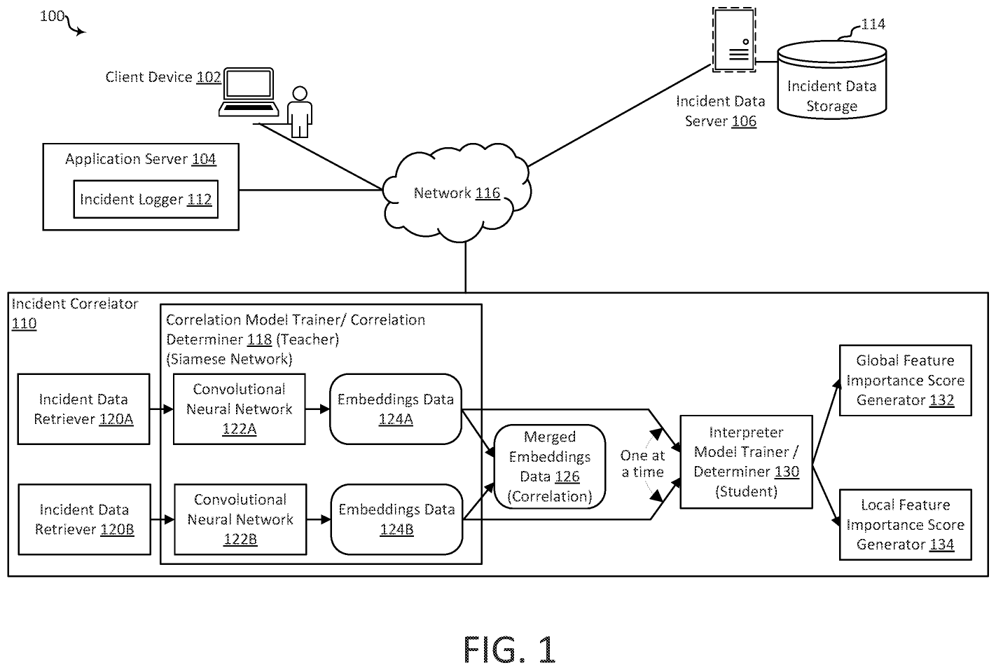

FIG. 1 illustrates an overview of an example system for determining correlations among data using a correlation model and interpreting the correlation model in accordance with aspects of the present disclosure. The system 100 includes a client device 102, an application server 104 with an incident logger 112, an incident data server 106 with an incident data storage 114, an incident correlator 110, connected by a network 116.

The client device 102 interacts with a user who reviews incident data and rectify issues described as incidents in the incident data. The user may interactively review analysis data associated with a behavior of a correlation model that correlate incident data (e.g., incident cases, or incident tickets).

An application server 104 performs various applications in the system 100, including logging of incidents that occur in the system 100. The incident logger 112 may monitor the system 100 for anomalies and logs (e.g., records) the anomalies as incident cases. The incident logger 112 may transmit the logged incident cases to the incident data server 106 over the network 116.

The incident data server 106 receives data associated with incidents and stores incident data in the incident data storage 114. The incident data storage may include a database for storing the incident data in a retrievable manner. In aspects, a set of incident data represents an incident case and includes values for attributes and features associated with the incident case. For example, the attributes and features may include but not limited to an incident case number, a title of an incident case, a topology of a system where the incident has occurred, a severity level, a status of the incident case, a source that has generated the incident case, a creation time of the incident case, and the like.

The incident correlator 110 determines correlations between a pair of or among three or more incident cases. In aspects, the incident correlator 110 includes at least an incident data retriever 120A and an incident data retriever 120B, a correlation model trainer/correlation determiner 118 (using a teacher model), an interpreter model trainer/determiner 130 (using a student model), a global feature importance score generator 132, and a local feature importance score generator 134.

The correlation model trainer/correlation determiner 118 (Teacher model) trains a correlation model based on training data. In an example, the correlation model includes a Siamese network. The Siamese network includes at least a pair of neural networks (e.g., a convolutional neural network 122A and a convolutional neural network 122B). The correlation model trainer/correlation determiner 118 (Teacher model) further determines a correlation between at a least a pair of data (e.g., incident data) using the at least a pair of trained neural networks.

In aspects, the correlation model trainer/correlation determiner 118 (Teacher model) trains the convolutional neural network 122A and the convolutional neural network 122B using training data include a pair of incident data and a ground truth correlation between the incident data. Once trained, the incident data retriever 120A and incident data retriever 120B respectively retrieves incident data that represents incident cases from the incident data server 106. The incident data retriever 120A provides incident data for an incident case to a convolutional neural network 122A as input. The incident data retriever 120B provides another incident data for another incident case to a convolutional neural network 122B as input. The convolutional neural network 122A generates embeddings data 124A based on the incident data from the incident data retriever 120A. The convolutional neural network 122B generates embeddings data 124A based on the incident data from the incident data retriever 120B.

In an example, the correlation model includes a Siamese Network. The Siamese Network according to the aspects of the present disclosure includes a pair of convolutional neural networks, respectively receiving incident data associated with an incident ticket and outputs embeddings associated with the respective incident data The Siamese Network generates merged embeddings that indicate correlation between the pair of incident data.

The incident correlator generates a correlation between the pair of incident data by merging the embeddings data 124A and the embeddings data 124B and generating the merged embeddings data 126 (correlation). In aspects, the merged embeddings data 126 indicates degrees of similarities of features associated with the pair of incident data.

In aspects, the present disclosure includes a teacher-student model for interpreting behavior of the correlation model (e.g., the Siamese Network). The correlation model represents the teacher model. The interpreter model represents the student model, which is trained based on a set of incident data and corresponding set of embeddings from the teacher model.

The interpreter model trainer/determiner 130 trains an interpreter model based on a set of training data representing an example incident case as input and embeddings that represent the example incident case as output. In aspects, the interpreter model is simpler in construction than the correlation model. The simpler construction of the interpreter model enables analyzing a behavior of the interpreter model that behaves similarly to the correlation model because of the teacher-student model including the correlation model as a teacher and the interpreter model as a student. Understanding a behavior of the interpreter model translates into understanding a behavior of the correlation model. In an example, the interpreter model trainer/determiner 130 receives either one the embeddings data 124A or the embeddings data 124B as incident embeddings (e.g., one at a time) and interpret an incident corresponding to the incident embeddings using the interpreter model.

After training the interpreter model, the global feature importance score generator 132 generates a set of global feature importance scores. A global feature importance score indicates a degree of importance (e.g., a degree of influence) of a feature (or an attribute) in incident data among the features in the incident data. For example, the global feature importance score generator 132 generates a set of global feature importance scores by generating permutative pairs of incident data. The global feature importance scores help determine a set of features that are important in accurately determining a correlation between a pair of incident tickets. Accordingly, the present disclosure enables generating training data with an emphasis on the determined set of features for training the convolutional networks in the correlation model (e.g., the Siamese Network).

After training the interpret model, the local feature importance score generator 134 generates a set of local feature importance scores. A local feature importance score indicates a degree of importance (e.g., a degree of influence) of features upon comparing feature values of a pair of incident tickets as predicted by the interpreter model. The local feature importance score generator 134 may further cause generating a visual presentation of important features between the pair incident tickets for an interactive review. In aspects, an incident resolution engineer may participate in the interactive review of the local feature importance and confirm that the behavior of the interpreter model, therefore the behavior of the correlation model, is in agreement with the incident resolution engineer. The agreement establishes a level of trust between the predictions by the interpreter model and incident assessments by the user.

As will be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

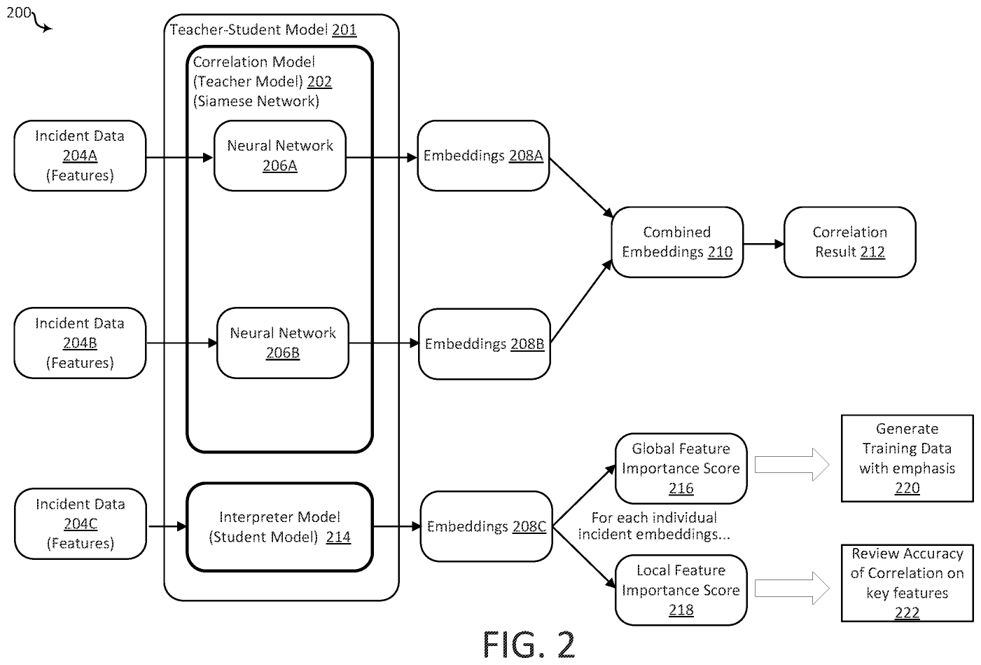

FIG. 2 illustrates an overview of data structures in accordance with aspects of the present disclosure. The data 200 includes a teacher-student model 201, a set of incident data (204A-D) as features, a correlation model (a teacher model) 202 including a set of neural networks 206A-B, a set of embeddings 108A-C, combined embeddings 210, a correlation result 212, an interpreter model (a student model) 214, a global feature importance score 216, and a local feature importance score 218.

The incident data 204A (features) and the incident data 204B (features) represent a pair of input data to the respective neural networks (206A and 206B) in the correlation model (teacher model 202). In aspects, the correlation model (a teacher model) 202 may include a Siamese Network.

The correlation model (teacher model) 202 outputs embeddings 208A that correspond to the incident data 204A and embeddings 208B that correspond to the incident data 204B. Training data for training the correlation model (teacher model) 202 may include a pair of incident data (204A and 204B) for training and embeddings (208A and 208B) as ground truth data that correspond to the respective incident data (204A and 204B). After the training, the correlation model may receive a pair of incident data (204A and 204B) and generate combined embeddings 210. The combined embeddings 210 indicate a degree of similarity between the two incident cases that the pair of incidence data correspond to. The correlation result 212 indicates whether features of the pair of incident tickets as input are similar or distinct.

The interpreter model (student model) 214 is a student model of the correlation model (teacher model) 202 in the teacher-student model 201. The interpreter model (student model) 214 is trained using the train data that trained the correlation model (teacher model) 202. Accordingly, the interpreter model (student model) 214 behaves similarly to the correlation model (teacher model) 202. In aspects, the interpreter model (student model) 214 includes a model that is similar in construction as compared to the correlation model (teacher model) 202. For example, the correlation model (teacher model) 202 may be a Siamese Network, which is complex because of its parallel structure of convolutional networks. In contrast the interpreter model (student model) 214 may include a less complex machine learning (ML) model (e.g., Random Forest, Gradient Boosting Regressor, a linear model, and the like). By use of the less complex model the interpreter model (student model) 214 generates embeddings as output from incident data as input more quickly as compared to the correlation model (teacher model) 202. The present disclosure further leverages the teacher-student model 201 to infer a behavior of the correlation model (teacher model) 202 by interpreting a behavior of the interpreter model (student model) 214. The simpler construction of the interpreter model (student model) 214 makes it practical to determine a behavior of the interpreter model (student model) 214. In contrast, it is often too complex and impractical to directly analyze and interpret behavior of the Siamese Network.

The embeddings 208C as output from the interpreter model (student model) 214 may be used as the basis to generate a global feature importance score 216 and a local feature importance score 218. In aspects, the global feature importance score 216 indicates a degree of influence of a feature as compared to other features in incident data. The global feature importance score helps identify one or more features that influences a level of accuracy of predicting a correlation between a pair of incidence cases. Accordingly, additional training data (e.g., pairs of incident cases and ground-truth correlations) with emphasis on the identified one or features may be generated for training the correlation model (teacher model) 202.

In aspects, the local feature importance score 218 indicates a degree of influence of one or more features and values in the features as predicted based on two distinct incident tickets. The local feature importance score 218 may be visually presented to enable interactively assessing whether the behavior of the interpreter model (student model) 214 for predicting correlation between incident cases is consistent with alternative and/or traditional assessment based on visual and manual inspections by human.

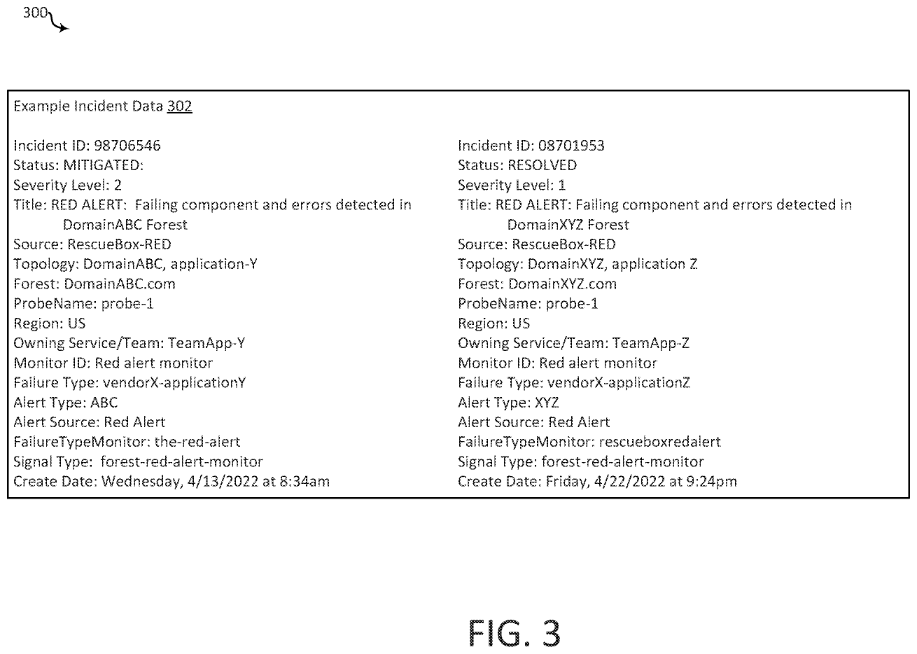

FIG. 3 illustrates example data structures of incident data in accordance with aspects of the present disclosure. In particular, FIG. 3 illustrates features and feature values associated with a pair of incident tickets. For example, a first incident ticket has an incident ID of 98706546, Status of “MITIGATED,” Severity level 2, Title “RED ALERT: Failing component and errors detected in DomainABC Forest,” Source of “RescueBox-RED,” Topology of “DomainABC, application-Y,” Forest of “DomainABC.com,” ProbeName of probe-1, Region “US,” Owning Service/Team of “TeamApp-Y,” Monitor ID of “Red alert monitor,” Failure Type of “vendorX-applicationY,” Alert Type “ABC,” Alert Source of “Red Alert,” FailureTypeMonitor of “the-red-alert,” Signal Type of “forest-red-alert-monitor,” and Create Date on “Wednesday, 4/13/2022 at 8:34 am.”

In an example, a second incident ticket includes an incident ID of 08701953, Status “RESOLVED,” Severity level of 1, Title “Failing component and errors detected in DomainXYZ Forest,” Source of “RescueBox-RED,” Topology of “DomainXYZ, application Z,” Forest of “DomainXYZ.com,” ProbeName of probe-1, Region “US,” Owning Service/Team of “TeamApp-Z,” Monitor ID of “Red alert monitor,” Failure Type of “vendorX-applicationZ,” Alert Type “XYZ,” Alert Source of “Red Alert,” FailureTypeMonitor of “rescueboxredalert,” Signal Type of “forest-red-alert-monitor,” and Create Date on “Friday, 4/22/2022 at 9:24 pm.”

In aspects, the neural network (e.g., the neural network 206A as shown in FIG. 2) of a correlation model (e.g., the correlation model (teacher model) 202 as shown in FIG. 2) receives the first incident data while the other network (the neural network 206B as shown in FIG. 2) receives the second incident data as input. The respective neural networks generate embeddings for the respective input and predicts a correlation between the two incident tickets as output.

In aspects, the interpreter model (e.g., the interpreter model (student model) 214 as shown in FIG. 2) receives data associated with a pair of incident cases (e.g., the first incident data and the second incident data) and generates embeddings (e.g., the embeddings 208C as shown in FIG. 2) for the respective incident data.

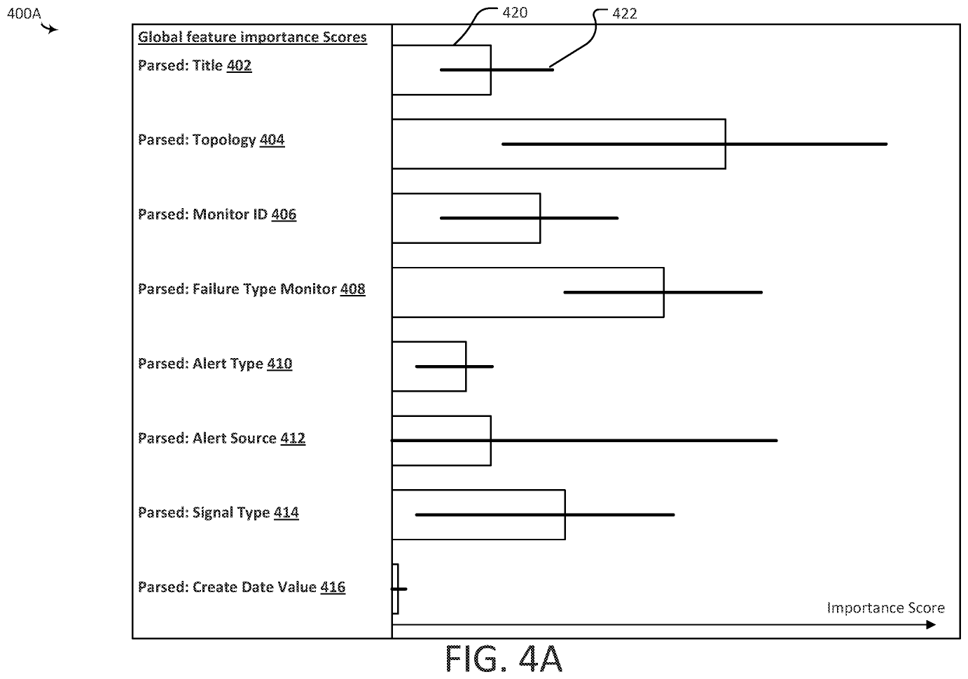

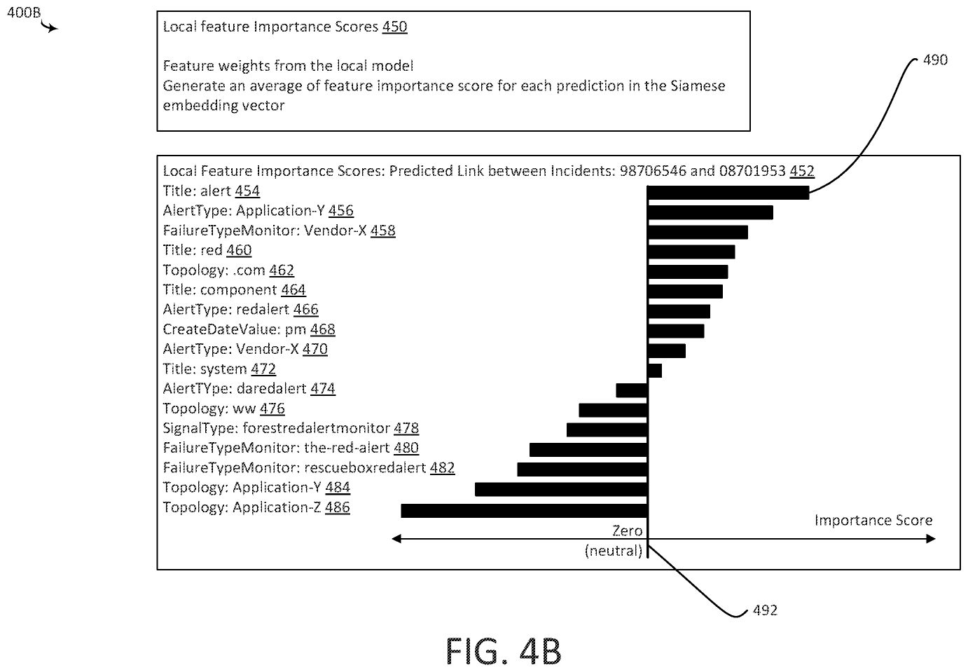

FIG. 4A illustrates an example of global feature importance scores in accordance with aspects of the present disclosure. In aspects, a global feature importance score indicates a degree of influence of a feature as compared to other features in data (e.g., incident data of an incident ticket) based on the interpreter model. In an example, the global feature importance score is based on all the data that have been used as training data to train both the correlation model (e.g., the correlation model (teacher model) 202 as shown in FIG. 2) and the interpreter model (e.g., the interpreter model (student model) 214 as shown in FIG. 2). Accordingly, the global feature importance scores indicate an overall behavior of the interpreter model. Furthermore, the global feature importance scores represent a result of interpreting a behavior of the correlation model because of the teacher-student model between the correlation model as the teacher and the interpreter model as the student model. In the example, a length of the horizontal bar 420 indicate a degree of influence associated with a feature (e.g., Title 402). A length of a horizontal line 422 indicate variances of the scores within respective features.

The example global feature importance scores 400A indicate features of “Topology” 404 and “Failure Type Monitor” 408 as the most important features because of the high scores of the respective features. In contrast, the feature “Create Date Value” 416 because of the lowest score. Based on the indication of the particular features of importance, the present disclosure enables determining one or more emphases on features for training the correlation model to improve a level of accuracy in predicting a correlation between a pair of incident tickets. For example, the example scores indicates that it is appropriate to generate training data with emphasis on training the correlation model on features “Topology” and “Feature Type Monitor.”

In aspects, the features as identified by the high global feature importance scores may be used to confirm whether the features are similar to a set of features that are heuristically considered as important in manually assessing incidents. Further understanding of influential features may be useful to further analyze incident cases for resolving incidents that occur in the system.

FIG. 4B illustrates an example of local feature importance scores in accordance with aspects of the present disclosure. In aspects, a local feature importance score indicates a level of importance of a word as a part of a value of a feature as compared to other words in the same feature or other features of incident data based on the interpreter model. Accordingly, a local feature importance score indicates feature weights from the interpreter model. Because of the teacher-student model between the correlation model (e.g., the Siamese Network) and the interpreter model, the respective local feature importance scores represent an average of feature importance scores for predictions of correlations as indicated the Siamese embedding vector.

The example local feature importance scores indicate a predicted link 452 between a pair of incident tickets (e.g., incident ticket IDs 98706546 and 08701953). In the example, a length of the horizontal bar 490 indicates a degree of influence of a word that appears in a feature for one of the pair of the incident tickets. The vertical line 492 indicates a point of neutrality between the two incident cases. Accordingly, the horizontal bar 490 indicates a relatively high importance of a word “alert” 454 that appears in a field “Title” for the incident ticket ID 08701953 as compared to the other incident ticket 98706546. In aspects, features in the two extremes in the graphical representation are more important than features with shorter horizontal bars from the vertical line 492 to either of the two directions.

Accordingly, the example local feature importance scores indicate the following features with values as more important than other features: a feature Title including words alert, red, a feature FeatureTypeMonitor including words the-red-alert, rescueboxredalert, a featureTopology including words Application-Y, Application-Z.

The disclosed technology may determine a local feature importance score by summarizing local feature importance scores by computing an average of scores associated with a feature across the pair of incidents. Additionally, or alternatively, the disclosed technology may determine a local feature importance score by summarizing feature importance scores regardless of whether specific feature values appear in one or both of the incidents.

In aspects, a result of the local feature importance scores enables confirming whether the features as identified based on the scores are in agreement with features that have been identified as important in analyzing incident cases for resolution based on a heuristic approach. Such an agreement helps operate the incident management systems with reliance in analyzing incidents.

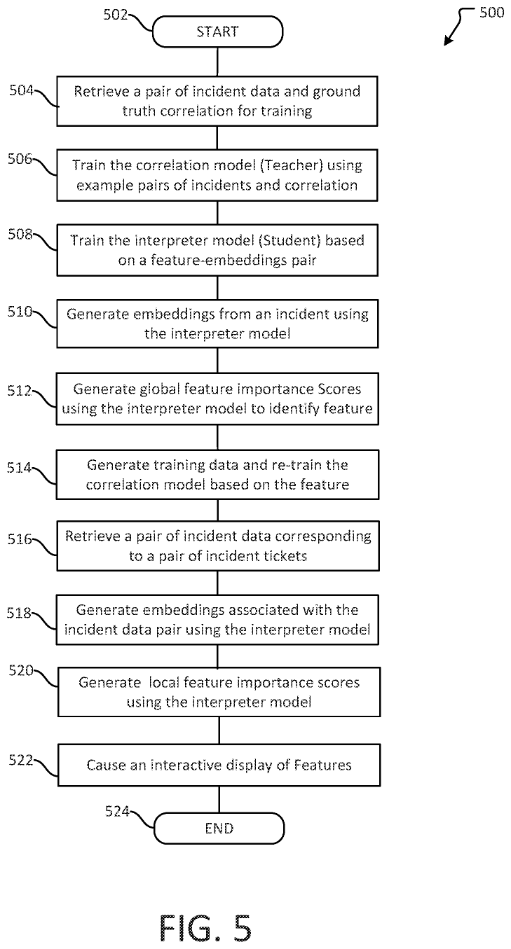

FIG. 5 illustrates an example of a method for interpreting a correlation model in accordance with aspects of the present disclosure. A general order of the operations for the method 500 is shown in FIG. 5. Generally, the method 500 begins with start operation 502 and ends with end operation 524. The method 500 may include more or fewer steps or may arrange the order of the steps differently than those shown in FIG. 5. The method 500 can be executed as a set of computer-executable instructions executed by a computer system and encoded or stored on a computer readable medium. Further, the method 500 can be performed by gates or circuits associated with a processor, an ASIC, an FPGA, a SOC or other hardware device. Hereinafter, the method 500 shall be explained with reference to the systems, components, devices, modules, software, data structures, data characteristic representations, signaling diagrams, methods, etc., described in conjunction with FIGS. 1, 2, 3, 4A-B, 6, and 7A-B.

Following start operation 502, the method 500 begins with retrieve operation 504, which retrieves a pair of incident data and ground truth correlation for training. The incident data includes a set of features and values associated with the respective features. A piece of incident data of the pair of the incident data may correspond to an incident ticket stored in an incident log storage.

Train the correlation model operation 506 trains the correlation model (teacher/a black box of a teacher-student model) using the retrieved pairs of incident data and correlation as training data. In an example, the correlation model includes a Siamese Network. In aspects, the correlation model includes a pair of convolutional neural networks, each uses one of the pair of incident data and its ground-truth correlation as training data.

Train the interpreter model operation 508 trains the interpreter model (student/a glass-box of the teacher-student model) using the training data. Upon completion of the training, the interpreter model predicts a correlation between a pair of incident data substantially the same as predictions made by the correlation model. In aspects, the interpreter model includes a machine learning that is less complex in its structure than the correlation model. Examples of the interpreter model may use Random Forest, Gradient Boosting Regressor, a linear model, and the like. The interpreter model as a glass-box model enables analyzing a behavior of the interpreter model and use the analyzed behavior to predict the embeddings at an incident level using the incident features. In aspects, the interpreter model has the goal of predicting the Siamese embeddings using the same incident features. In some aspects, the interpreter model no longer predicts a correlation between pair of incidents but rather predicts the embeddings at the incident level.

Generate embeddings operation 510 generates embeddings from incident data that represents an incident case (or an incident ticket in an incident log) using the interpreter model. In aspects, the interpreter uses features (e.g., incident data) as input and generates embeddings as output. The embeddings may include a multi-dimensional vector that captures features of the incident data. In an example, a number of dimensions of the multi-dimensional vector represents a number of features in the incident data used for predicting a correlation.

Generate global feature importance scores operation 512 generates a set of global feature importance scores from the trained interpreter model. In aspects, a global feature importance score indicates a level of importance of a feature as compared to other features in incident data based on the trained interpreter model as a student/glass-box model of the teacher-student model. A use of the global feature importance scores enables identifying one or more features that are important for attaining a level of accuracy in predicting a correlation between incident cases. Because of the correlation model being the teacher model (e.g., the black box model), the present disclosure interprets a behavior of the correlation model based on the set of global feature importance scores as generated from the trained interpreter model.

Generate training data operation 514 generates a set of training data and re-trains the correlation model based on the important features as identified using the global feature importance scores. The training data may include a pair of example incident data and a ground-truth correlation between the pair of example incident data with an emphasis on the important features as identified based on the global feature importance scores. Alternatively, the set of training data generated at operation 514 can be used to train new models, rather than retraining an existing model, without departing from the scope of this disclosure.

Retrieve a pair of incident data operation 516 retrieves a pair of incident data, each corresponding to a distinct incident ticket, from an incident log storage (e.g., the incident data storage 114 attached to the incident data server 106 as shown in FIG. 1).

Generate embeddings operation 518 generates embeddings associated with the retrieved pair of incident data using the trained interpreter model. In aspects, the interpreter model may receive a set of incident data (e.g., one incident ticket) as input and generate embeddings associated with the set of incident data. The interpreter model may be used twice to generate embeddings associated with the respective incident data of the pair of the incident data.

Generate local feature importance scores operation 520 generates a set of local feature importance scores based on the pair of incident data. In aspects, the local feature importance scores indicate a degree of influence associated with words that appear in respective features of the pair of the incident data. Local feature importance scores indicate a degree of influence of each prediction link from the Siamese Network for review.

Cause operation 522 causes an interactive review of features that are found to be important for accurately determining a correlation between a pair of incident tickets. The interactive review of features with high local feature importance scores helps confirming whether the predictions made by the interpreter model is consistent with a heuristic task of correlating a pair of incident cases. The method 500 ends with the end operation 524.

As should be appreciated, operations 502-524 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

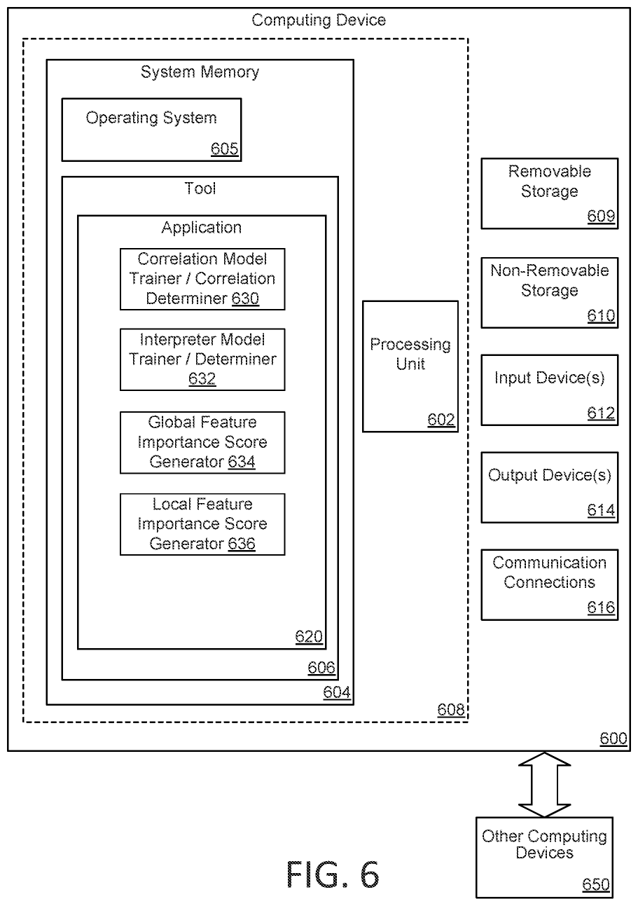

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program tools 606 suitable for performing the various aspects disclosed herein such. The operating system 605, for example, may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program tools and data files may be stored in the system memory 604. While executing on the at least one processing unit 602, the program tools 606 (e.g., an application 620) may perform processes including, but not limited to, the aspects, as described herein. The application 620 includes a correlation model trainer/correlation determiner 630, an interpreter model trainer/determiner 632, a global feature importance score generator 634, a local feature importance score generator 636 as described in more details in FIG. 1. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 600 may also have one or more input device(s) 612, such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of the communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

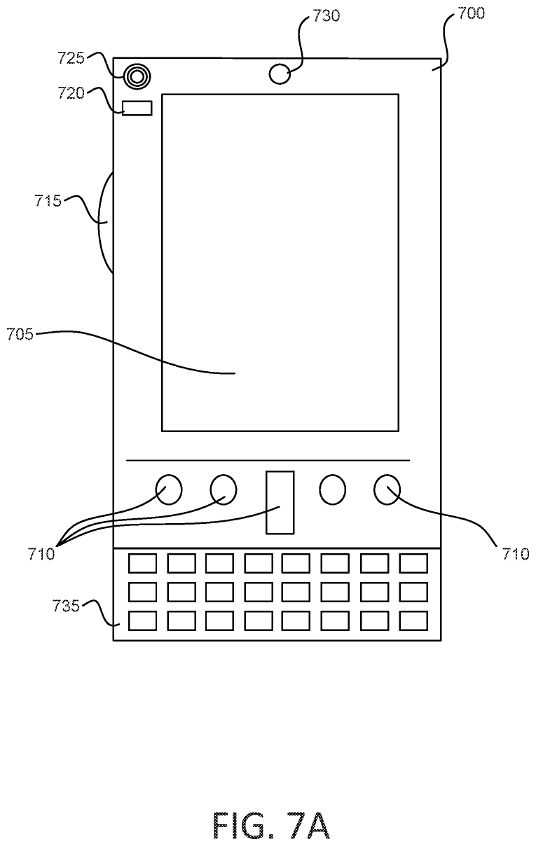

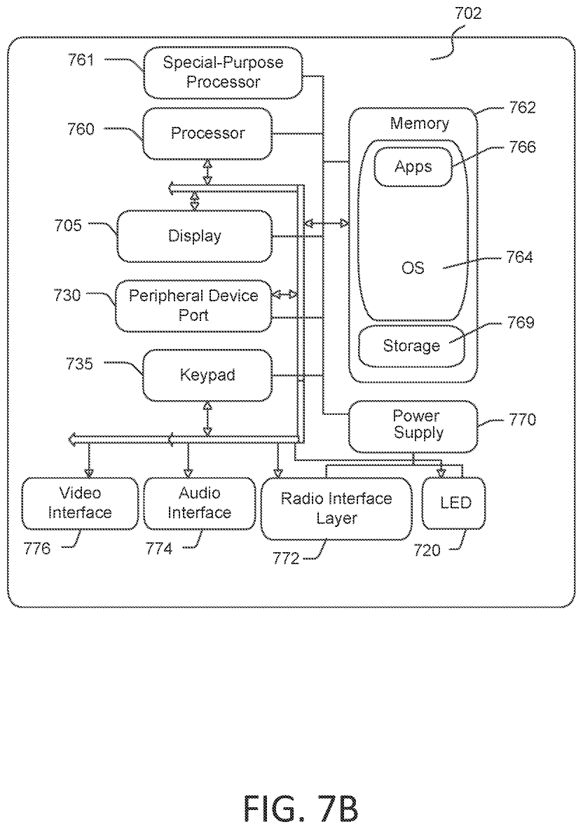

FIGS. 7A and 7B illustrate a computing device or mobile computing device 700, for example, a mobile telephone, a smart phone, wearable computer (such as a smart watch), a tablet computer, a laptop computer, and the like, with which aspects of the disclosure may be practiced. In some aspects, the client utilized by a user (e.g., the client device 102 as shown in the system 100 in FIG. 1) may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included as an optional input element, a side input element 715 allows further user input. The side input element 715 may be a rotary switch, a button, or any other type of manual input element. In alternative aspects, mobile computing device 700 may incorporate more or less input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of computing device, a server (e.g., an application server 104, an incident data server 106, and an incident correlator 110, as shown in FIG. 1), a mobile computing device, etc. That is, the mobile computing device 700 can incorporate a system 702 (e.g., a system architecture) to implement some aspects. The system 702 can implemented as a “smart phone” capable of running one or more applications (e.g., browser, e-mail, calendaring, contact managers, messaging clients, games, and media clients/players). In some aspects, the system 702 is integrated as a computing device, such as an integrated digital assistant (PDA) and wireless phone.

One or more application programs 766 may be loaded into the memory 762 and run on or in association with the operating system 764. Examples of the application programs include phone dialer programs, e-mail programs, information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 868 synchronized with corresponding information stored at the host computer. As should be appreciated, other applications may be loaded into the memory 762 and run on the mobile computing device 700 described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 (e.g., LED) may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of devices connected to a peripheral device port 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to systems and methods for interpreting a correlation model according to at least the examples provided in the sections below. A computer-implemented method comprises retrieving, a first pair of sets of data as at least a part of training data, wherein a set of data includes a feature with a value associated with the feature, and wherein the training data further includes a ground-truth correlation between a first set of data and a second set of data in the first pair of sets of data; training an interpreter model using the training data, wherein the interpreter model interprets a behavior of a correlation model trained based on the training data, wherein the correlation model predicts a correlation between the first pair of sets of data; identifying, based on a first score associated with the interpreter model, the feature as an emphasis for retraining the correlation model; generating, based on the identified feature, additional training data with the emphasis on the identified feature; and retraining the correlation model using the additional training data. The set of data includes incident data, the method further comprises generating, based at least on a first incident data of a received second pair of incident data, embeddings associated with the first incident data of the received second pair of incident data using the interpreter model; generating a second score based at least on the embeddings associated with the first incident data of the received second pair of incident data; and causing, based on the second score, interactive displaying of one or more features associated with the first incident data of the received second pair of incident data. The correlation model represents a teacher of a teacher-student model, wherein the interpreter model represents a student of the teacher-student model, wherein of the behavior of the interpreter model includes inferring the behavior of the correlation model, and wherein the correlation model includes a Siamese Network including a plurality of neural networks to generate embeddings associated with the second pair of data. The set of data includes incident data describing an incident, and wherein a set of incident data includes one or more features, and wherein the one or more features include at least: an incident identifier of the incident, a title, a severity level of the incident, a status of the incident, a topology of a system associated with the incident, or a timestamp associated with occurrence of the incident. The first score represents a global feature importance score, and wherein the global feature importance score indicates a degree of influence of the feature relative to other features in a plurality of sets of data. The second score represents a local feature importance score, and wherein the local feature importance score indicates a degree of influence of a combination of the feature and a word appearing in the value associated with the feature relative to other features in a plurality of sets of data. The training data is based on permutative combinations of pairs of sets of data. The embeddings include a multi-dimensional vector representation, and wherein a number of dimensions of the embeddings is based on a number of features associated with the set of data. The embeddings represent Siamese embeddings. The interpreter model includes one of: Random Forest, Gradient Boosting Regressor, or a linear model.

Another aspect of the technology relates to a system. The system comprises a processor; and a memory storing computer-executable instructions that when executed by the processor cause the system to execute a method comprising: retrieving, a first pair of sets of incident data as at least of a part of training data from an incident log storage, wherein a set of incident data represents an incident ticket, wherein the set of incident data includes a feature with a value associated with the feature, and the training data further includes a ground-truth correlation between a first set of incident data and a second set of incident data of the first pair of sets of incident data; training a correlation model using the training data; training an interpreter model using the training data, wherein the interpreter model interprets a behavior of the correlation model; generating, based at least on a first incident data of a received second pair of incident data, embeddings associated with the first incident data of the received second pair of incident data using the interpreter model; generating a local feature importance score based at least on the embeddings associated with the first incident data of the received second pair of incident data; and causing, based on the local feature importance score, an interactive display of one or more features associated with the first incident data of the received second pair of incident data. The computer-executable instructions that when further executed by the processor cause the system to execute a method comprises generating, based at least on the embeddings associated with the first incident data of the received second pair of incident data, a global feature importance score associated with the set of data using the interpreter model; identifying, based at least on the global feature importance score, a feature associated with the first incident data of the received second pair of incident data; generating, based on the identified feature, additional training data; and retraining the correlation model using the additional training data. The correlation model represents a teacher of a teacher-student model, wherein the interpreter model represents a student of the teacher-student model, wherein of the behavior of the interpreter model infers the behavior of the correlation model, and wherein the correlation model includes a Siamese Network including a plurality of neural networks to generate embeddings associated with the second pair of incident data. The set of incident data includes one or more features, and wherein the one or more features include at least: an incident identifier of an incident, a title, a severity level of the incident, a status of the incident, a topology of a system associated with the incident, or a timestamp associated with occurrence of the incident. The global feature importance score indicates a degree of influence of the feature relative to other features in a plurality of sets of incident data. The local feature importance score indicates a degree of influence of a combination of the feature and a word appearing in the value associated with the feature relative to other features in a plurality of sets of incident data stored.

In still further aspects, the technology relates to a computer-implemented method. The computer-implemented method comprises retrieving, a first pair of sets of incident data as at least a part of training data, wherein a set of incident data represents an incident ticket, wherein the set of incident data includes a feature with a value associated with the feature, and the training data further includes a ground-truth correlation between a first set of incident data and a second set of incident data in a pair of the sets of incident data; training a correlation model using the training data, wherein the correlation model represents a teacher of a teacher-student model; training an interpreter model using the training data, wherein the interpreter model represents a student of the teacher-student model; generating a global feature importance score associated with a feature of the sets of incident data using the interpreter model, wherein the global feature importance score indicates a degree of influence of the feature relative to other features in a plurality of sets of incident data; identifying a feature based at least on the global feature importance score; generating, based on the identified feature, additional training data; retraining the correlation model using the additional training data; generating, based on a received second pair of incident data, embeddings associated with the received second pair of incident data using the interpreter model; generating a local feature importance score based on received incident data and embeddings associated with the received second pair of incident data, wherein the local feature importance score indicates the degree of influence of a combination of the feature and a word appearing in the value associated with the feature relative to other features in a plurality of sets of incident data; and causing, based on the local feature importance score, an interactive display of one or more features associated with the second pair of incident data. The correlation model uses a Siamese Network including a plurality of convolutional neural networks. The interpreter model interprets a behavior of the correlation model, wherein the correlation model predicts correlations among a plurality of sets of incident data, and wherein the interpreter model includes at least one of: Random Forest, Gradient Boosting Regressor, or a linear model. The set of incident data includes one or more features, and wherein the one or more features include at least: an incident identifier of an incident, a title, a severity level of the incident, a status of the incident, a topology of a system associated with the incident, or a timestamp associated with occurrence of the incident.

Any of the one or more above aspects in combination with any other of the one or more aspect. Any of the one or more aspects as described herein.

What is claimed is:

1. A computer-implemented method, the method comprising:
retrieving, a first pair of sets of data as at least a part of training data, wherein a set of data includes a feature with a value associated with the feature, and wherein the training data further includes a ground-truth correlation between a first set of data and a second set of data in the first pair of sets of data;
training an interpreter model using the training data, wherein the interpreter model interprets a behavior of a correlation model trained based on the training data, wherein the correlation model predicts a correlation between the first pair of sets of data;
identifying, based on a first score associated with the interpreter model, the feature as an emphasis for retraining the correlation model;
generating, based on the identified feature, additional training data with the emphasis on the identified feature; and
retraining the correlation model using the additional training data.

2. The computer-implemented method of claim 1, wherein the set of data includes incident data, the method further comprising:
generating, based at least on a first incident data of a received second pair of incident data, embeddings associated with the first incident data of the received second pair of incident data using the interpreter model;
generating a second score based at least on the embeddings associated with the first incident data of the received second pair of incident data; and
causing, based on the second score, interactive displaying of one or more features associated with the first incident data of the received second pair of incident data.

3. The computer-implemented method of claim 1,
wherein the correlation model represents a teacher of a teacher-student model, wherein the interpreter model represents a student of the teacher-student model,
wherein of the behavior of the interpreter model includes inferring the behavior of the correlation model, and
wherein the correlation model includes a Siamese Network including a plurality of neural networks to generate embeddings associated with the second pair of data.

4. The computer-implemented method of claim 1, wherein the set of data includes incident data describing an incident, and wherein a set of incident data includes one or more features, and wherein the one or more features include at least:
an incident identifier of the incident,
a title,
a severity level of the incident,
a status of the incident,
a topology of a system associated with the incident, or
a timestamp associated with occurrence of the incident.

5. The computer-implemented method of claim 1, wherein the first score represents a global feature importance score, and wherein the global feature importance score indicates a degree of influence of the feature relative to other features in a plurality of sets of data.

6. The computer-implemented method of claim 2, wherein the second score represents a local feature importance score, and wherein the local feature importance score indicates a degree of influence of a combination of the feature and a word appearing in the value associated with the feature relative to other features in a plurality of sets of data.

7. The computer-implemented method of claim 2, wherein the training data is based on permutative combinations of pairs of sets of data.

8. The computer-implemented method of claim 2, wherein the embeddings include a multi-dimensional vector representation, and wherein a number of dimensions of the embeddings is based on a number of features associated with the set of data.

9. The computer-implemented method of claim 2, wherein the embeddings represent Siamese embeddings.

10. The computer-implemented method of claim 1, wherein the interpreter model includes one of:
Random Forest,
Gradient Boosting Regressor, or
a linear model.

11. A system comprising:
a processor; and
a memory storing computer-executable instructions that when executed by the processor cause the system to execute a method comprising:
retrieving, a first pair of sets of incident data as at least of a part of training data from an incident log storage, wherein a set of incident data represents an incident ticket, wherein the set of incident data includes a feature with a value associated with the feature, and the training data further includes a ground-truth correlation between a first set of incident data and a second set of incident data of the first pair of sets of incident data;
training a correlation model using the training data;
training an interpreter model using the training data, wherein the interpreter model interprets a behavior of the correlation model;
generating, based at least on a first incident data of a received second pair of incident data, embeddings associated with the first incident data of the received second pair of incident data using the interpreter model;
generating a local feature importance score based at least on the embeddings associated with the first incident data of the received second pair of incident data; and
causing, based on the local feature importance score, an interactive display of one or more features associated with the first incident data of the received second pair of incident data.

12. The system of claim 11, the computer-executable instructions that when further executed by the processor cause the system to execute a method comprising:
generating, based at least on the embeddings associated with the first incident data of the received second pair of incident data, a global feature importance score associated with the set of incident data using the interpreter model;
identifying, based at least on the global feature importance score, a feature associated with the first incident data of the received second pair of incident data;
generating, based on the identified feature, additional training data; and
retraining the correlation model using the additional training data.

13. The system of claim 11,
wherein the correlation model represents a teacher of a teacher-student model, wherein the interpreter model represents a student of the teacher-student model,
wherein of the behavior of the interpreter model infers the behavior of the correlation model, and
wherein the correlation model includes a Siamese Network including a plurality of neural networks to generate embeddings associated with the second pair of incident data.

14. The system of claim 11, wherein the set of incident data includes one or more features, and wherein the one or more features include at least:
an incident identifier of an incident,
a title,
a severity level of the incident,
a status of the incident,
a topology of a system associated with the incident, or
a timestamp associated with occurrence of the incident.

15. The system of claim 12, wherein the global feature importance score indicates a degree of influence of the feature relative to other features in a plurality of sets of incident data.

16. The system of claim 11, wherein the local feature importance score indicates a degree of influence of a combination of the feature and a word appearing in the value associated with the feature relative to other features in a plurality of sets of incident data stored.

17. A computer-implemented method, comprising:
retrieving, a first pair of sets of incident data as at least a part of training data, wherein a set of incident data represents an incident ticket, wherein the set of incident data includes a feature with a value associated with the feature, and the training data further includes a ground-truth correlation between a first set of incident data and a second set of incident data in a pair of the sets of incident data;
training a correlation model using the training data, wherein the correlation model represents a teacher of a teacher-student model;
training an interpreter model using the training data, wherein the interpreter model represents a student of the teacher-student model;
generating a global feature importance score associated with a feature of the sets of incident data using the interpreter model, wherein the global feature importance score indicates a degree of influence of the feature relative to other features in a plurality of sets of incident data;
identifying a feature based at least on the global feature importance score;
generating, based on the identified feature, additional training data;
retraining the correlation model using the additional training data;
generating, based on a received second pair of incident data, embeddings associated with the received second pair of incident data using the interpreter model;
generating a local feature importance score based on received incident data and embeddings associated with the received second pair of incident data, wherein the local feature importance score indicates the degree of influence of a combination of the feature and a word appearing in the value associated with the feature relative to other features in a plurality of sets of incident data; and
causing, based on the local feature importance score, an interactive display of one or more features associated with the second pair of incident data.

18. The computer-implemented method of claim 17, wherein the correlation model uses a Siamese Network including a plurality of convolutional neural networks.

19. The computer-implemented method of claim 17, wherein the interpreter model interprets a behavior of the correlation model, wherein the correlation model predicts correlations among a plurality of sets of incident data, and wherein the interpreter model includes at least one of:
Random Forest,
Gradient Boosting Regressor, or
a linear model.

20. The computer-implemented method of claim 17, wherein the set of incident data includes one or more features, and wherein the one or more features include at least:
an incident identifier of an incident,
a title,
a severity level of the incident,
a status of the incident,
a topology of a system associated with the incident, or
a timestamp associated with occurrence of the incident.
